(19) United States
(12) Patent Application Publication
(10) Pub. No.: US 2012/0056473 A1
(43) Pub. Date: Mar. 8, 2012

(54) ROLLER WHEEL FOR TRACK-TYPE TRAVELLING VEHICLE

(75) Inventors: Akira Hashimoto, Dallas, TX (US); Tatsuo Yamashita, Osaka (JP); Hiroyuki Nakaishi, Osaka (JP)

(73) Assignee: KOMATSU LTD., Minato-ku, Tokyo (JP)

(21) Appl. No.: 13/320,096

(22) PCT Filed: May 31, 2010
(86) PCT No.: PCT/JP2010/059174

§ 371 Date: Nov. 11, 2011

(30) Foreign Application Priority Data
Jun. 1, 2009 (JP) 2009-131815

(51) Int. Cl. B62D 55/14

(52) U.S. Cl. 305/136

(57) ABSTRACT

A roller wheel for a track-type travelling vehicle is disposed on a non-ground-engaging side of a track and supported by a vehicle body frame. The roller wheel includes a shaft, a roller assembly and a bearing. The shaft is supported by the vehicle body frame. The roller assembly is disposed on an outer periphery of the shaft. The bearing allows the roller assembly to be rotatably supported by the shaft therethrough. The roller assembly includes a tubular inner roller shell disposed closer to the vehicle body frame, and a tubular outer roller shell disposed outwards of the inner roller, the tubular outer roller shell being coupled to the inner roller shell by a straddle fitting structure.

### CROSS-REFERENCE TO RELATED APPLICATIONS

This national phase application claims priority to Japanese Patent Application No. 2009-131815 filed on Jun. 1, 2009. The entire disclosure of Japanese Patent Application No. 2009-131815 is hereby incorporated herein by reference.

### FIELD OF THE INVENTION

The present invention relates to a roller wheel for a track-type travelling vehicle, and particularly to, a roller wheel for a track-type travelling vehicle, which is supported by a vehicle body frame while being disposed on a non-ground-engaging side of a track (crawler belt).

### BACKGROUND ART

The track-type travelling vehicles (also referred to as crawler-type travelling vehicles) have been popular as vehicles, such as bulldozers and hydraulic excavators, mainly used for works on irregular terrain. In the track-type travelling vehicles, a drive unit includes two pairs of a driving wheel and an idler tumbler on the transverse sides thereof. The driving wheel and the idler tumbler on each transverse side are disposed back and forth while being wrapped by an endless track (also referred to as an endless crawler belt). Further, in the track-type travelling vehicles, a plurality of roller wheels is disposed between the driving wheel and the idler tumbler on the non-ground-engaging side (i.e., the side opposite to the ground) of each track. The roller wheels are supported by the vehicle body frame. The roller wheels can ensure ground-engaging power in travelling of the vehicle and also stably support the vehicle body.

For example, Japan Laid-open Patent Application Publication No. JP-A-2004-149111 describes roller wheels of the aforementioned type. In the publication, each roller wheel includes a shaft and roller shells supported by shaft through bearings. Further, a sealing mechanism is disposed between the shaft and the axial outer end of each roller shell while being supported by a sealing support member.

In the roller wheels especially illustrated in FIG. 4 of the publication, a roller assembly is formed by a pair of right and left roller shells and a coupling ring. Specifically, each of the right and left roller shells has a stepped fitting portion on the outer periphery thereof, and the stepped fitting portions of the both roller shells are faced to each other. The coupling ring is press-inserted into the stepped fitting portions for coupling the right and left roller shells.

The roller wheels described in the publication has an advantageous feature that the right and left roller shells can be easily assembled without being coupled by means of welding.

When the coupling ring is press-inserted into the outer peripheries of the right and left roller shells, however, the coupling-ring fitted portions of the both roller shells are deformed to the inner peripheral side. Accordingly, the inner peripheries of the both roller shells are easily deformed. The inner peripheries of the both roller shells are rotatably supported by the shaft through the bushings. However, the bushings and the shaft unevenly make contact with each other when the inner peripheries of the both roller shells are partially deformed to the inner peripheral side.

It is an object of the present invention to provide roller wheels for a track-type travelling vehicle for inhibiting uneven contact between the shaft and the roller shells including bearings such as bushings.

### SUMMARY OF THE INVENTION

A roller wheel for a track-type travelling vehicle according to a first aspect of the present invention is of a type that is disposed on a non-ground-engaging side of a track and is supported by a vehicle body frame. The roller wheel includes a shaft, a roller assembly and a bearing. The shaft is supported by the vehicle body frame. The roller assembly is disposed on an outer periphery of the shaft. The bearing allows the roller assembly to be rotatably supported by the shaft therethrough. The roller assembly includes a tubular inner roller shell and a tubular outer roller shell. The inner roller shell is disposed closer to the vehicle body frame. The outer roller shell is disposed outwards of the inner roller shell. The tubular outer roller shell is coupled to the inner roller shell by means of a straddle fitting structure.

The term “inner” position/side refers to a side/position closer to the vehicle body frame, i.e., a side/position closer to the center of the vehicle in the transverse direction. On the other hand, the term “outer” side/position refers to a side/position away from the vehicle.

According to the roller wheel of the first aspect of the present invention, the inner and outer roller shells are coupled to each other with the straddle fitting structure. For example, the inner and outer roller shells are coupled by a predetermined member, while at least either of the outer peripheries of the inner and outer roller shells is partially straddled by the predetermined member. Alternatively, the inner and outer roller shells are coupled to each other, while one of the outer peripheries of the inner and outer roller shells is partially straddled by the other thereof and/or vice versa.

In this case, the inner and outer roller shells are coupled by means of the straddle fitting structure not by means of a coupling ring press-fitted onto the outer peripheries of the inner and outer roller shells. Therefore, uneven contact can be inhibited between the shaft and the bearing (e.g., a bushing) disposed in the inner peripheries of the roller shells without causing inward deformation of each roller shell.

A roller wheel for a track-type travelling vehicle according to a second aspect of the present invention relates to the roller wheel for a track-type travelling vehicle according to the first aspect of the present invention. In the roller wheel, the straddle fitting structure includes an inner engaging portion, an outer engaging portion and a coupling ring. The inner engaging portion is formed on an outer periphery of an outer end of the inner roller shell. The outer engaging portion is formed on an outer periphery of an inner end of the outer roller shell. The coupling ring is engaged astride with the inner and outer engaging portions for coupling the inner and outer roller shells.

According to the roller wheel of the second aspect of the present invention, the coupling ring is fitted astride with the inner and outer engaging portions.

A roller wheel for a track-type travelling vehicle according to a third aspect of the present invention relates to the roller wheel for a track-type travelling vehicle according to the second aspect of the present invention. In the roller wheel, each of the inner and outer engaging portions of the inner and outer roller shells includes an annular groove partially having an axially extended protrusion in a circumferential direction thereof. Further, the coupling ring includes a plurality of split rings. Each of the split rings includes a pair of legs fitted into the annular grooves of the inner and outer roller shells. Each of the legs partially has an engaging portion engaged with a corresponding one of the protrusions of the annular grooves.

The term “axial” direction herein refers to a direction along the rotational axes of the inner and outer roller shells.

According to the roller shell of the third aspect of the present invention, a part of each split ring without formation of the engaging portion is inserted into the annular grooves of the inner and outer roller shells, and subsequently, the split rings are rotated. The engaging portions are accordingly engaged with the protrusions of the annular grooves. Thus, the inner and outer roller shells are fixed to each other. Therefore, the inner and outer roller shells can be fixed by the simple structure.

A roller wheel for a track-type travelling vehicle according to a fourth aspect of the present invention relates to the roller wheel for a track-type travelling vehicle according to the third aspect of the present invention. In the roller wheel, the split rings are two half-split rings respectively formed in a semicircular shape.

A roller wheel for a track-type travelling vehicle according to a fifth aspect of the present invention relates to the roller wheel for a track-type travelling vehicle according to the fourth aspect of the present invention. In the roller wheel, each of the half-split rings includes an engaging part and a groove. The engaging part is formed in one of circumferential ends thereof. The engaging part is engaged with the engaging part of the other of the half-split rings. The groove is axially formed in the other of the circumferential ends thereof. In addition, the coupling ring further includes a fixation member to be press-fitted into the groove of the half-split rings for fixing the half-split rings.

A roller wheel for a track-type travelling vehicle according to a sixth aspect of the present invention relates to the roller wheel for a track-type travelling vehicle according to the fourth aspect of the present invention. In the roller wheel, each of the half-split rings includes a radially penetrating through hole in each of the both circumferential ends thereof. The coupling ring further includes two pins for fixing the half-split rings. Each pin herein penetrates through the through holes formed in the corresponding circumferential ends of the half-split rings.

A roller wheel for a track-type travelling vehicle according to a seventh aspect of the present invention relates to the roller wheel for a track-type travelling vehicle according to the second aspect of the present invention. In the roller wheel, each of the inner and outer engaging portions of the inner and outer roller shells includes a protrusion extended radial outwards. The coupling ring is an annular member including a pair of legs on an inner periphery thereof for allowing the pair of legs to be engaged with the protrusions of the inner and outer roller shells.

According to the roller wheel of the seventh aspect of the present invention, the inner and outer roller shells can be coupled by engaging the coupling ring with the protrusions formed in the inner and outer roller shells. Therefore, it is herein possible to achieve the same advantageous effects as those achieved by the aforementioned aspects.

A roller wheel for a track-type travelling vehicle according to an eighth aspect of the present invention relates to the roller wheel for a track-type travelling vehicle according to the seventh aspect of the present invention. In the roller wheel, each of the protrusions of the inner and outer roller shells is tapered. The outer diameter of each of the protrusions is increased in proportion to distance from the other of the inner and outer roller shells.

According to the roller wheel of the eighth aspect of the present invention, each protrusion is tapered. Therefore, the coupling ring can be easily fitted onto the respective inner and outer roller shells.

A roller wheel for a track-type travelling vehicle according to a ninth aspect of the present invention relates to the roller wheel for a track-type travelling vehicle according to the eighth aspect of the present invention. In the roller wheel, each of the inner and outer roller shells includes the protrusion continuously on the entire circumference thereof.

A roller wheel for a track-type travelling vehicle according to a tenth aspect of the present invention relates to the roller wheel for a track-type travelling vehicle according to the seventh aspect of the present invention. In the roller wheel, the coupling ring includes at least an axial slit for easy elastic deformation thereof.

According to the roller wheel of the tenth aspect of the present invention, the coupling ring includes a slit. Therefore, the coupling ring is elastically deformable easily in fitted onto the inner and outer roller. Accordingly, it is possible to easily attach the roller assembly onto the shaft.

A roller wheel for a track-type travelling vehicle according to an eleventh aspect of the present invention relates to the roller wheel for a track-type travelling vehicle according to the seventh aspect of the present invention. In the roller wheel, each of the outer and inner ends with the protrusions in the inner and outer roller shells is elastically deformable radially inwards.

According to the roller wheel of the eleventh aspect of the present invention, each of the outer and inner ends with protrusions in the inner and outer roller shells is elastically deformed in fitting the coupling ring onto the respective inner and outer roller shells. Therefore, it is possible to easily attach the roller assembly onto the shaft.

A roller wheel for a track-type travelling vehicle according to a twelfth aspect of the present invention relates to the roller wheel for a track-type travelling vehicle according to the first aspect of the present invention. In the roller wheel, the straddle fitting structure includes an inner interlocking portion and an outer interlocking portion. The inner interlocking portion is formed on an outer end of the inner roller shell. The outer interlocking portion is formed on an inner end of the outer roller shell. The straddle fitting structure is a structure for coupling the inner and outer roller shells while one of the inner and outer interlocking portions of the inner and outer roller shells is interlocked astride with the other of the inner and outer interlocking portions of the inner and outer roller shells.

The term “inner” side/position herein refers to a side/position closer to the vehicle body frame, i.e., a side/position closer to the center of the vehicle in the transverse direction. On the other hand, the term “outer” side/position refers to a side away from the vehicle.

According to the roller wheel of the twelfth aspect of the present invention, the roller shell is split only into the inner and outer roller shells. Even when a sealing mechanism is disposed on the both ends of the roller shells, another member is not required for supporting the sealing mechanism. In other words, it is not required to form screw holes in the roller shells. Therefore, it is possible to easily manufacture the roller assembly.

Further, the inner and outer roller shells are coupled through the interlocking of the engaging portions thereof. Therefore, the inner and outer roller shells are not inwardly deformed. Accordingly, uneven contact can be inhibited between the shaft and the bearing (e.g., a bush) disposed in the inner peripheries of the inner and outer roller shells.

A roller wheel for a track-type travelling vehicle according to a thirteenth aspect of the present invention relates to the roller wheel for a track-type travelling vehicle according to the twelfth aspect of the present invention. In the roller wheel, at least one of the inner and outer interlocking portions of the inner and outer roller shells includes an interlocking protrusion extended radial inwards, whereas at least the other of the inner and outer interlocking portions of the inner and outer roller shells includes an interlocked groove for allowing the interlocking protrusion to be engaged therein.

According to the roller shell of the thirteenth aspect of the present invention, the inner and outer roller shells are coupled through the interlocking protrusion/protrusions and the interlocking groove/grooves. Therefore, the inner and outer roller shells can be coupled with the simple structure.

A roller wheel for a track-type travelling vehicle according to a fourteenth aspect of the present invention relates to the roller wheel for a track-type travelling vehicle according to the thirteenth aspect of the present invention. In the roller wheel, at least either of the inner and outer interlocking portions of the inner and outer roller shells has a radial thickness less than a radial thickness of the other part of the corresponding one or both of the inner and outer roller shells.

According to the roller wheel of the fourteenth aspect of the present invention, at least either of the inner and outer interlocking portions of the inner and outer roller shells has a thickness less than that of the other part of the corresponding one or both of the inner and outer roller shells. Therefore, the tip/tips (i.e., the interlocking portion/portions) of either/both of the inner and outer roller shells is/are elastically deformable easily when the interlocking protrusion/protrusions and the interlocking groove/grooves, formed on the interlocking portions, are interlocked. Accordingly, the inner and outer roller shells can be easily coupled.

A roller wheel for a track-type travelling vehicle according to a fifteenth aspect of the present invention relates to the roller wheel for a track-type travelling vehicle according to the fourteenth aspect of the present invention. In the roller wheel, at least either of the inner and outer roller shells includes a tapered outer peripheral surface on the end thereof including the interlocking groove, and the tapered outer peripheral surface has a diameter reduced towards a tip thereof from the interlocking groove.

According to the roller wheel of the fifteenth aspect of the present invention, the outer peripheral surface/surfaces of the end/ends of the inner and outer roller shells is/are tapered. Therefore, it is possible to easily interlock the interlocking protrusion/protrusions with the interlocking groove/grooves.

A roller wheel for a track-type travelling vehicle according to a sixteenth aspect of the present invention relates to the roller wheel for a track-type travelling vehicle according to the fifteenth aspect of the present invention. In the roller wheel, at least either of the inner and outer interlocking portions includes a plurality of axially extended slits.

The term “axial” direction herein refers to a direction along the rotational axes of the inner and outer roller shells.

According to the roller wheel of the sixteenth aspect of the present invention, either of the interlocking protrusions includes a plurality of slits. Therefore, the interlocking protrusion with the slits can more easily expand or reduce the diameter thereof. Accordingly, it is possible to more easily interlock the interlocking protrusion/protrusions with the interlocking groove/grooves.

A roller wheel for a track-type travelling vehicle according to a seventeenth aspect of the present invention relates to the roller wheel for a track-type travelling vehicle according to the thirteenth aspect of the present invention. In the roller wheel, the interlocking groove includes an annular sealing-member attaching groove on a bottom surface thereof, and the straddle fitting structure further includes a sealing member disposed in the annular groove formed therein. Further, the interlocking protrusion is press-contacted to the sealing member with an inner peripheral surface thereof.

According to the roller wheel of the seventeenth aspect of the present invention, the sealing member can inhibit the lubricant residing in the inside of the roller wheel from leaking to the outside.

A roller wheel for a track-type travelling vehicle according to an eighteenth aspect of the present invention relates to the roller wheel for a track-type travelling vehicle according to the twelfth aspect of the present invention. In the roller wheel, the inner and outer interlocking portions of the inner and outer roller shells include slanted surfaces radially faced to each other, and the straddle fitting structure further includes a wedge ring to be inserted between the slanted surfaces thereof. The wedge ring is herein partially notched for expanding a diameter thereof. Further, the inner and outer interlocking portions of the inner and outer roller shells are interlocked through the wedge ring.

According to the roller wheel of the eighteenth aspect of the present invention, the interlocking portions of the inner and outer roller shells are interlocked through the wedge ring. Therefore, the inner and outer roller shells can be herein also coupled with the simple structure.

A roller wheel for a track-type travelling vehicle according to a nineteenth aspect of the present invention relates to the roller wheel for a track-type travelling vehicle according to the twelfth aspect of the present invention. In the roller wheel, one of the inner and outer interlocking portions of the inner and outer roller shells includes a male threaded portion on an outer peripheral surface thereof, whereas the other of the inner and outer interlocking portions of the inner and outer roller shells includes a female threaded portion allowing the male threaded portion to be screwed therein.

According to the roller wheel of the nineteenth aspect of the present invention, the interlocking portions of the inner and outer roller shells are interlocked by means of a screw structure, and the inner and outer roller shells are thereby coupled to each other. The inner and outer roller shells can be herein also coupled with the simple structure.

Overall, according to the aforementioned present invention, it is possible to inhibit inward deformation of each roller shell and uneven contact between the shaft and the bearing disposed in the inner periphery of each roller.

### BRIEF DESCRIPTION OF THE DRAWINGS

Referring now to the attached drawings which form a part of this original disclosure:

FIG. 1 is a vertical cross-sectional view of a roller wheel for a track-type travelling vehicle according to a first exemplary embodiment of the present invention;

FIG. 2 is a detailed partial cross-sectional view illustrating engaging portions of the roller wheel;

FIG. 3 is a diagram of a coupling ring of the roller wheel;

FIG. 4 is a schematic diagram for explaining an attachment work of the roller wheel;

FIG. 5 is a schematic diagram for explaining the attachment work of the roller wheel;

FIG. 6 is a diagram of a roller wheel according to a modification of the first exemplary embodiment of the present invention;

FIG. 7 is a diagram of a roller wheel according to another modification of the first exemplary embodiment of the present invention;

FIG. 8 is a diagram of a roller wheel according to yet another modification of the first exemplary embodiment of the present invention;

FIG. 9 is a vertical cross-sectional view of a roller wheel for a track-type travelling vehicle according to a second exemplary embodiment of the present invention;

FIG. 10 is a detailed partial cross-sectional view illustrating engaging portions of the roller wheel according to the second exemplary embodiment of the present invention;

FIG. 11 is a diagram of a coupling ring of the roller wheel according to the second exemplary embodiment of the present invention;

FIG. 12 is a schematic diagram for explaining an attachment work of the roller wheel according to the second exemplary embodiment of the present invention;

FIG. 13 is a diagram of a roller wheel according to a modification of the second exemplary embodiment;

FIG. 14 is a vertical cross-sectional view of a roller wheel for a track-type travelling vehicle according to a third exemplary embodiment of the present invention;

FIG. 15 is a detailed partial cross-sectional view illustrating engaging portions of the roller wheel;

FIG. 16 is a diagram of a roller wheel according to a third exemplary embodiment of the present invention;

FIG. 17 is a diagram, corresponding to FIG. 15, of a fourth exemplary embodiment of the present invention;

FIG. 18 is a diagram, corresponding to FIG. 15, of a fifth exemplary embodiment of the present invention; and

FIG. 19 is a diagram of a roller wheel according to a modification of the fifth exemplary embodiment of the present invention.

### DETAILED DESCRIPTION OF THE EMBODIMENTS

### First Exemplarly Embodiment

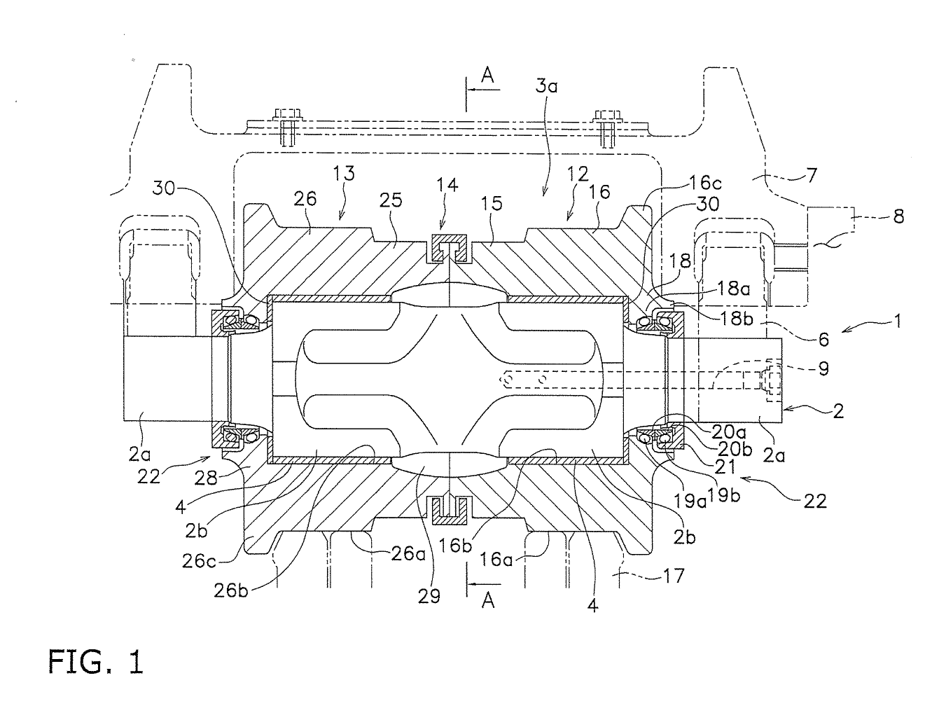

FIG. 1 illustrates a vertical cross-sectional view of each of roller wheels 1 for a track-type (crawler-type) travelling vehicle according to a first exemplary embodiment of the present invention. The roller wheels 1 are disposed on a non-ground-engaging side (i.e., a side opposite to the ground) of each of a pair of tracks (crawler belts). Each roller wheel 1 includes a shaft 2, a roller assembly 3a and two bushings 4 as bearings.

### Shaft

The shaft 2 includes a pair of small-diameter support portions 2a on the both ends thereof (i.e., the inner and outer ends thereof in the axial direction). Further, the shaft 2 includes a pair of bearing attached portions 2b in the axial center part thereof where the roller assembly 3a is disposed. The diameter of each bearing attached portion 2b is herein greater than that of each support portion 2a. The term “inner” side/position (and its related term such as inward, inside and so forth) herein basically refers to a side/position closer to a vehicle body frame 8 (i.e., the right side in FIG. 1), whereas the term “outer” side/position (and its related term such as outward, outside and so forth) basically refers to a side/position away from the vehicle body frame 8 (i.e., the left side in FIG. 1). The support portions 2a are respectively supported by a large bogie 7 through a pair of small bogies 6. Further, the large bogie 7 is fixed to the vehicle body frame 8. In other words, the shaft 2 is indirectly supported by the vehicle body frame 8. Further, the shaft 2 includes an oil supply port 9. The oil supply port 9 is outwardly formed from an inner end of the shaft 2 and is communicated to the outer peripheral surface of the shaft 2. It should be noted that the shaft 2 includes a recess in the axial center part thereof, i.e., a part interposed between the bearing attached portions 2b.

### Roller Assembly

The roller assembly 3a includes an inner roller shell 12, an outer roller shell 13 and a coupling ring 14. The inner roller shell 12 is disposed on the inner position closer to the vehicle body frame 8, while the outer roller shell 13 is disposed outwards of the inner roller shell 12. The coupling ring 14 couples the inner and outer roller shells 12 and 13. The inner and outer roller shells 12 and 13 are symmetrical with respect to the coupling plane thereof. Therefore, only the inner roller shell 12 will be hereinafter explained in detail.

The inner roller shell 12 has a tubular shape and includes an inner coupling portion 15 and an inner tread portion 16. In the inner roller shell 12, the inner coupling portion 15 and the inner tread portion 16 are axially aligned from the outside to the inside (i.e., from left to right in FIG. 1).

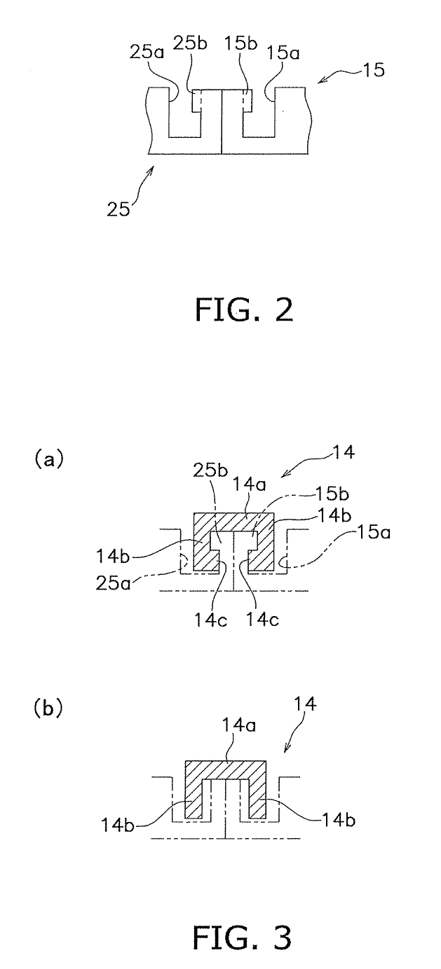

As illustrated in an enlarged view of FIG. 2, the inner coupling portion 15 includes an inner annular groove 15a on the outer periphery of the outer end thereof. The inner annular groove 15a is concentric to the rotational axis of the roller wheel 1. The inner annular groove 15a includes two protrusions 15b on the outer periphery of one of the axial sidewalls (i.e., the outer sidewall). The protrusions 15b are protruded axial inwards and disposed concentric to the rotational axis of the roller wheel 1. Each protrusion 15b has a quadrant-arc shape. More specifically, each protrusion 15b occupies quadrant of the circular outer periphery of the outer sidewall. The protrusions 15b are symmetrically disposed with respect to the rotational axis of the roller wheel 1. In other words, two portions, interposed between the protrusions 15 in the circumferential direction of the annular groove 15a, respectively occupy quadrant of the circular outer periphery of the outer sidewall.

The diameter of the inner tread portion 16 is greater than that of the inner coupling portion 15. The inner tread portion 16 includes a tread surface 16a on the outer peripheral surface thereof for making contact with track links 17. Further, the inner tread portion 16 includes a bearing attached surface 16b on the inner peripheral surface thereof. Yet further, the inner tread portion 16 includes an annular flange 16c on the innermost part thereof. The diameter of the annular flange 16c is greater than that of the other part of the inner tread portion 16.

Further, the inner roller shell 12 includes an inner boss 18 disposed further inwards of the inner tread portion 16. The inner boss 18 is formed in the radial inner part of the inner end of the inner roller shell 12. The inner boss 18 includes an inner peripheral protrusion 18a and an inner protrusion 18b. The inner peripheral protrusion 18a is annularly protruded radial inwards, whereas the inner protrusion 18b is annularly protruded axial inwards. A floating seal 22 is attached to the protrusions 18a and 18b. The floating seal 22 includes two O rings 19a and 19b, two sealing rings 20a and 20b and a snap ring 21.

As described above, the inner and outer roller shells 12 and 13 are formed symmetric to each other. Therefore, the outer roller shell 13 includes “an outer coupling portion 25”, “an outer tread portion 26”, “an outer annular groove 25a”, “protrusions 25b”, “a tread surface 26a”, “a bearing attached surface 26b”, “an annular flange 26c” and “an outer boss 28”, respectively corresponding to “the inner coupling portion 15”, “the inner tread portion 16”, “the inner annular groove 15a”, “the protrusions 15b”, “the tread surface 16a”, “the bearing attached surface 16b”, “the annular flange 16c” and “the inner boss 18” of the inner roller shell 12. Further, a floating seal of the same type as the floating seal 22, including two O rings, two sealing rings and a snap ring, is attached to the outer boss 28 of the outer roller 13, similarly to the structure of the inner boss 18 of the inner roller shell 12.

The coupling ring 14 is formed by two semicircular split rings 14 (the reference numeral “14” will be hereinafter assigned to both of “the coupling ring” and “the split rings”). The split rings 14 have exactly the same structure. As illustrated in an enlarged view of FIG. 3, each split ring 14 has a C-shaped cross section. Specifically, each split ring 14 includes a main body 14a and a pair of legs 14b. The main body is an axially extended outer peripheral portion of the split ring 14. The legs 14b are extended from the both axial ends of the main body 14a to the inner periphery of the split ring 14. Further, each leg 14b includes an engaging portion 14c protruded inwards (i.e., towards the other leg 14b). It should be noted that each engaging portion 14c occupies less than quadrant of the circular inner periphery of the coupling ring 14 (i.e., the split rings 14). Two pairs of the engaging portions 14c are symmetrically disposed with respect to the center of the coupling ring 14 (i.e., the split rings 14). The legs 14b are fitted into the inner and outer annular grooves 15a and 25a formed in the inner and outer coupling portions 15 and 25. Specifically, the engaging portions 14c are respectively engaged with parts, disposed radial inwards of the protrusions 15b and 25b, of the inner and outer annular grooves 15a and 25a while straddling the protrusions 15b and 25b. It should be noted that FIG. 3 includes a cross-sectional view (a) of a part of the legs 14b where the engaging portions 14c are formed and a cross-sectional view (b) of a part of the legs 14b where the engaging portions 14c are not formed.

With the aforementioned structure, the inner and outer roller 12 and 13 are integrally coupled by the split rings 14, with the axially faced ends thereof being abutted to each other. It should be noted that an oil reservoir 29 for lubricating oil is formed in the inner peripheral side of the split rings 14, more specifically, in a space produced between the shaft 2 and the inner periphery of the axial center part of the coupled inner and outer roller shells 12 and 13.

### Bearing

The bushings 4 are respectively attached to the bearing attached surfaces 16b and 26b of the inner and outer roller shells 12 and 13. Therefore, the irmer and outer roller shells 12 and 13 are rotatably supported by the shaft 2 through the bushings 4. Further, thrust washers 30 are respectively disposed between the axial ends of the bearing attached portions 2b and the edges of the inner and outer roller shells 12 and 13 in order to receive thrust force.

### Attachment

When the roller assembly 3a is attached onto the shaft 2, the thrust washers 30 are inserted into the inner peripheries of the inner and outer roller shells 12 and 13, and the bushings 4 are further inserted therein. Next, the inner and outer roller shells 12 and 13 are attached onto the shaft 2 from the both support portion 2a sides while the thrust washers 30 and the bushings 4 are attached thereto for allowing the axial edges of the inner and outer roller shells 12 and 13 to be abutted to each other as illustrated in FIG. 1. It should be noted that the angles of the inner and outer roller shells are herein required to be preliminarily positioned for matching the circumferential positions of the protrusions 15b and 25b of the annular grooves 15a and 25a foiiiied in the inner and outer roller shells 12 and 13.

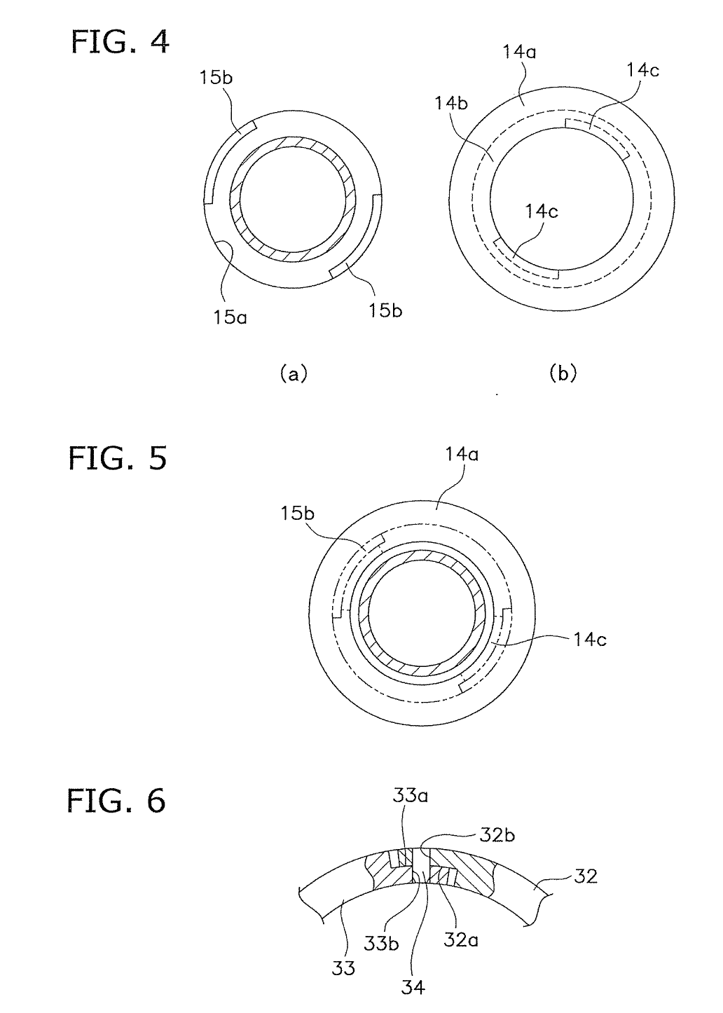

Next, the split rings 14 are fitted into the inner and outer annular grooves 15a and 25a of the inner and outer roller shells 12 and 13. FIG. 4 illustrates the shapes of the irmer roller shell 12 and the coupling ring 14 when axial-outwardly seen from an axial inner position (sectioned along an arrow A-A in FIG. 1) at the time of fitting. Specifically, the split rings 14 are firstly positioned for matching the circumferential positions of the engaging portions 14c formed on a pair of the legs 14b of the split rings 14 with those of the parts of the inner and outer annular grooves 15a and 25a where the protrusions 15b and 25b are not formed, as illustrated in the schematic views (a) and (b) of FIG. 4. In the condition, the engaging portions 14c do not hit the protrusions 15b and 25b. Therefore, a pair of the legs 14b of each split ring 14 can be fitted into the annular grooves 15a and 25a.

The split rings 14, thus fitted into the inner and outer annular grooves 15a and 25a, are rotated for matching the circumferential positions of the engaging portions 14c with those of the parts of the inner and outer annular grooves 15a and 25a where the protrusions 15b and 25b are formed, as illustrated in FIG. 5. Accordingly, the engaging portions 14c are engaged with the parts, formed radial inwards of the protrusions 15b and 25b, of the inner and outer annular grooves 15a and 25a, as illustrated in FIG. 3.

With the aforementioned structure, the inner and outer roller shells 12 and 13 are coupled to each other. Subsequently, the floating seals 22 are respectively attached to the bosses 18 and 28 of the inner and outer roller shells 12 and 13.

### Features

(1) The inner and outer roller shells 12 and 13 are coupled by the coupling ring 14. The coupling ring 14 is herein engaged with the grooves formed on the inner peripheries of the inner and outer roller shells 12 and 13 astride the protrusions of the grooves. This prevents deformation of the inner and outer roller shells 12 and 13. Therefore, it is possible to prevent uneven contact between the shaft 2 and the bushings 4 disposed in the inner peripheries of the inner and outer roller shells 12 and 13.

(2) The roller shell is split into only the inner and outer roller shells 12 and 13, and members for supporting the floating seals 22 are integrated with the roller shells. Therefore, it is not required to form screw holes in the roller shells for fixing the support members to the roller shells. It is possible to reduce the number of components of the roller assembly, easily manufacture the roller assembly and easily attach the roller assembly onto the shaft

(3) It is possible to attach the roller assembly onto the shaft without using a large-sized press machine or the like. It is thereby possible to easily attach the roller assembly onto the shaft.

### Modification of First Exemplary Embodiment

(a) The shapes and the number of the engaging portion of the coupling ring 14, the annular grooves and the protrusions formed in each of the inner and outer roller shells 12 and 13 are not limited to those in the aforementioned exemplary embodiment. For example, the coupling ring 14 may include three or more engaging portions. Further, either or both of each protrusion and each engaging portion may include a circumferentially slanted surface(s). Accordingly, when being rotated and attached to the roller shells, the coupling ring (i.e., the split rings) may be configured to be rigidly fixed thereto in accordance with rotation thereof.

(b) As illustrated in FIG. 6, two split rings may be coupled by means of pins. In the example illustrated in FIG. 6, a split ring 32, which is one of the two split rings 32 and 33, includes an engaging notch 32a on the inner peripheral part of each circumferential end thereof. Further, the split ring 32 includes a through hole 32b on the tip of each circumferential end thereof. Each through hole 32b penetrates the split ring 32 from the outer peripheral surface to the corresponding engaging notch 32a. On the other hand, the other split ring 33 includes an engaging notch 33a on the outer peripheral part of each circumferential end thereof. Further, the split ring 33 includes a through hole 33b on the tip of each circumferential end thereof. Each through hole 33b radially penetrates the corresponding circumferential end of the split ring 33 where the engaging notch 33a is formed. Pins 34 are herein inserted into two pairs of the overlapped through holes 32b and 33b.

In the present modification of the first exemplary embodiment, the split rings 32 and 33 can be rigidly fixed by means of the pins 34. Therefore, it is possible to more easily fit the split rings 32 and 33 into the grooves of the inner and outer roller shells 12 and 13.

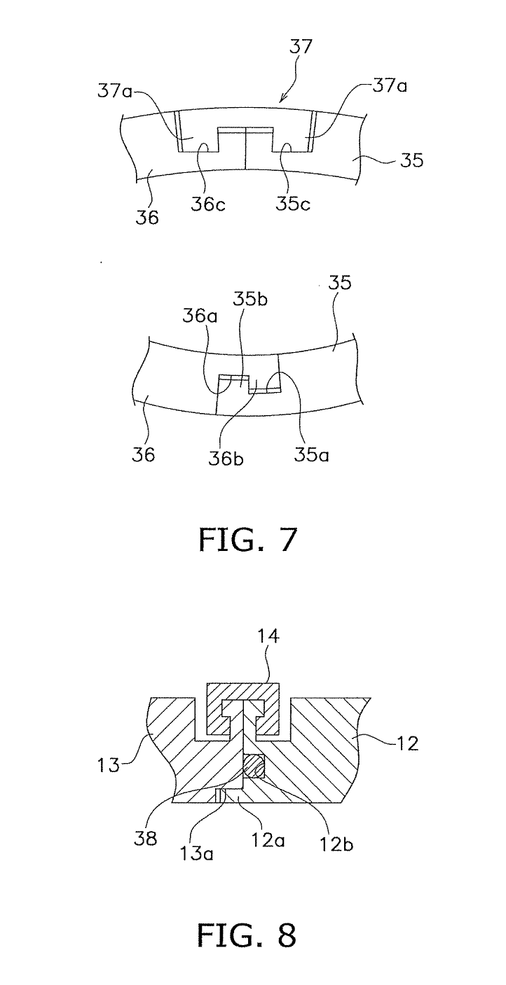

(c) Two split rings may be coupled as illustrated in FIG. 7. In the example, each of two split rings 35 and 36 includes a first engaging groove 35a/36a and an engaging protrusion 35b/36b on one circumferential end thereof. The engaging protrusion 35b is engaged with the first engaging groove 36a, while the engaging protrusion 36b is engaged with the first engaging groove 35a.

Further, each of the split rings 35 and 36 includes a second engaging groove 35c/36c on the other of the other circumferential end thereof. A pair of legs 37a of a coupling member 37 is press-fitted into the second engaging grooves 35c and 36c.

With the present modification of the first exemplary embodiment, the split rings 35 and 36 can be also rigidly fixed by means of the coupling member 37. Therefore, it is possible to more easily fit the split rings 35 and 36 to the grooves of the inner and outer roller shells 12 and 13.

(d) FIG. 8 illustrates yet another example. In the example illustrated in FIG. 8, in addition to the structure of the aforementioned first exemplary embodiment, the inner roller shell 12 includes a convex 12a on the inner peripheral part of the outer edge thereof, whereas the outer roller shell 13 includes a concave 13a on the inner peripheral part of the inner edge thereof. The convex 12a is fitted into the concave 13a for joining the inner roller shell 12 to the outer roller shell 13. The inner periphery of the joint part is smoothly formed without a step. Further, the inner roller shell 12 includes an annular groove 12b for a sealing purpose on the outer edge thereof, and an O ring 38 is attached as a sealing member to the annular groove 12b.

In the present modification of the first exemplary embodiment, the inner and outer roller shells 12 and 13 can be accurately positioned by means of the aforementioned convex-concave joint. Further, the O ring 38 is disposed on the contacted surfaces of the inner and outer roller shells 12 and 13. It is thereby possible to further inhibit leakage of lubricating oil residing within the inner and outer roller shells 12 and 13.

### Second Exemplarly Embodiment

### Structure

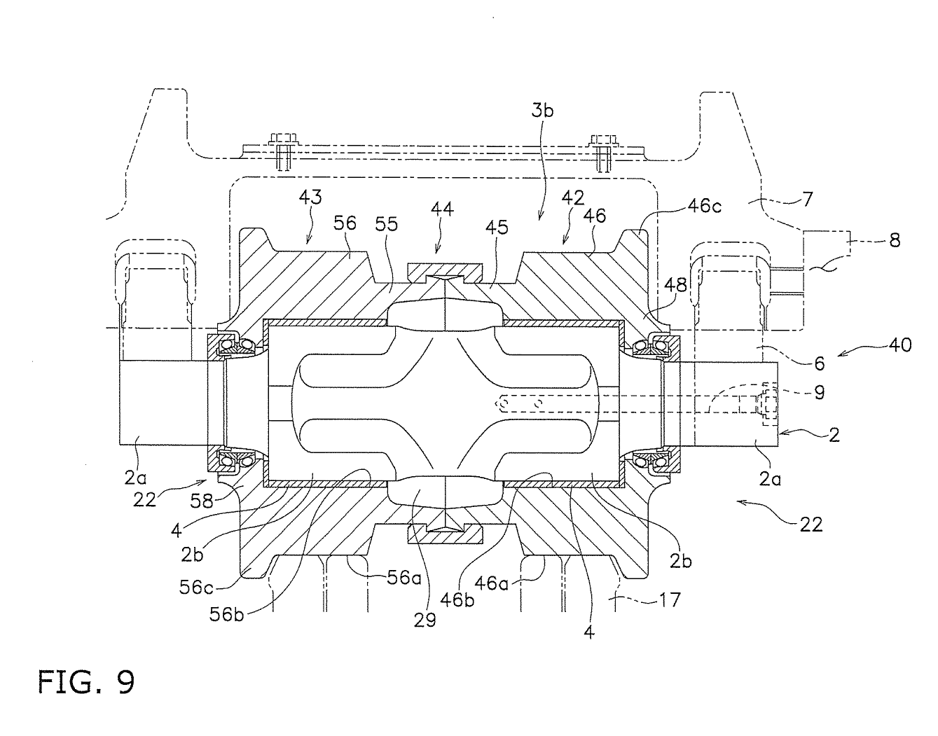

FIG. 9 illustrates a roller wheel 40 according to a second exemplary embodiment of the present invention. The roller wheel 40 of the second exemplary embodiment has basically the same structure as that of the first exemplary embodiment, excluding components forming a roller assembly, i.e., an inner roller shell, an outer roller shell and a coupling ring. Only the components different from those of the first exemplary embodiment will be hereinafter explained.

Similarly to the first exemplary embodiment, a roller assembly 3b includes an inner roller shell 42, an outer roller shell 43 and a coupling ring 44. The inner roller shell 42 is disposed on the inner position closer to the vehicle body frame, while the outer roller shell 43 is disposed outwards of the inner roller shell 42. The coupling ring 44 couples the inner and outer roller shells 42 and 43.

The inner roller shell 42 has a tubular shape and includes an inner coupling portion 45 and an inner tread portion 46. In the inner roller shell 42, the inner coupling portion 45 and the inner tread portion 46 are axially aligned from the outside to the inside.

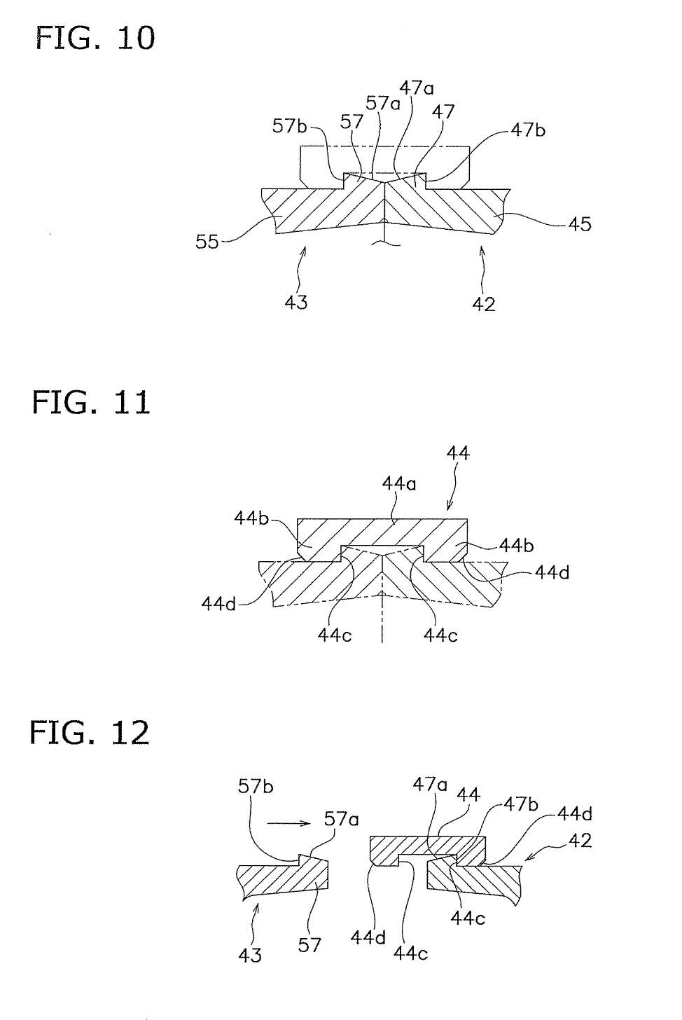

As illustrated in an enlarged view of FIG. 10, the inner coupling portion 45 includes an annular protrusion 47 on the outer periphery of the outer end thereof. The protrusion 47 is extended radial outwards. An outer peripheral surface 47a of the protrusion 47 is tapered, and the diameter thereof is thereby increased towards the inside in proportion to increase in distance away from the outer roller shell 43. Further, the axial inner edge of the protrusion 47 is formed as an interlocking surface 47b.

The diameter of the inner tread portion 46 is greater than that of the inner coupling portion 45. Similarly to the first exemplary embodiment, the inner tread portion 46 includes a tread surface 46a, a bearing attached surface 46b and an annular flange 46c. Further similarly to the first exemplary embodiment, the inner tread portion 46 includes an inner boss 48 and a floating seal 22 is attached to the inner boss 48.

The outer roller shell 43 is symmetric to the inner roller shell 42 with respect to the coupling plane of the both shells. Therefore, the outer roller shell 43 similarly includes an outer coupling portion 55, an outer tread portion 56, a protrusion 57, an outer peripheral surface 57a, an interlocking surface 57b, a tread face 56a and a bearing attached surface 56b, an annular flange 56c and an outer boss 58. Further, another floating seal 22 is attached to the outer boss 58 of the outer roller shell 43.

The coupling ring 44 is an annular member having a predetermined length (width) in the axial direction. As illustrated in an enlarged view of FIG. 11, the coupling ring 44 includes a main body 44a and a pair of legs 44b. The main body 44a is axially extended as the outer periphery of the coupling ring 44. The legs 44b are extended from the both axial ends of the main body 44a to the inner peripheral side. The inner surface of each leg 44b (i.e., the surface faced to the other leg) functions as an interlocking surface 44c to be interlocked with the interlocking surface 47b/57b of each roller shell 42/43. It should be noted that each leg 44b includes a bevel 44d on the inner peripheral part of the outer surface thereof (i.e., the surface opposite to the interlocking surface 44c).

With the above structure, the inner and outer roller shells 42 and 43 are coupled by means of the coupling ring 44.

### Attachment

When the roller assembly 3b is attached onto the shaft 2, the thrust washers 30 are respectively inserted into the inner peripheries of the inner and outer roller shells 42 and 43 and the bushings 4 are then respectively attached therein, similarly to the first exemplary embodiment. Next, either of the inner and outer roller shells 42 and 43 is attached onto the shaft 2 from the support portion 2a side while the thrust washer 30 and the bushing 4 are attached therein. For example, the inner roller shell 42 is herein firstly attached onto the shaft 2. Then, the coupling ring 44 is fitted to the tip of the coupling portion 45 of the inner roller shell 42. Specifically, when the coupling ring 44 is pressed inwards, the bevel 44d thereof is disposed on the tapered outer peripheral surface 47a of the protrusion 47 formed on the tip of the inner roller shell 47. When the coupling ring 44 is further pressed inwards from the position, the tips of the coupling ring 44 and the inner roller shell 42 are deformed and the leg 44b of the coupling ring 44 is disposed across the protrusion 47. Finally, the interlocking surfaces 47b and 44c are interlocked with each other. FIG. 12 illustrates the interlocked condition.

Next, the coupling ring 44 receives the outer roller shell 43. As illustrated in FIG. 12, the outer roller shell 43 is pressed into the coupling ring 44. The coupling ring 44 is thereby interlocked with the protrusion 57 of the outer roller shell 43 in the same procedure as that of interlocking the coupling ring 44 with the protrusion 47 of the inner roller shell 42. Thus, the inner and outer roller shells 42 and 43 are coupled to each other while the coupling ring 44 is engaged with the inner and outer roller shells 42 and 43 astride the protrusions 47 and 57. Features

The roller wheel 40 of the second exemplary embodiment has roughly the same features of the roller wheel 1 of the first exemplary embodiment. Further in the roller wheel 40, the protrusions 47 and 57 and the coupling ring 44 are respectively formed in an annular shape. Therefore, it is possible to easily manufacture the roller wheel 40. Yet further, the coupling ring 44 is not split into pieces. In other words, the coupling ring 44 can be simply structured.

### Modification of Second Exemplary Embodiment

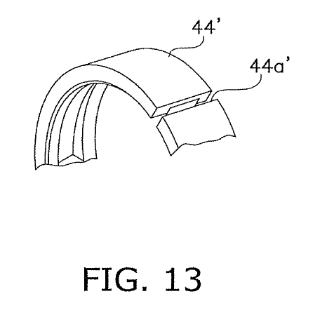

(a) The shapes of the protrusions and the coupling ring are not limited to those of the second exemplary embodiment. For example, as illustrated in FIG. 13, a coupling ring 44′ may be formed as a C-shaped snap ring having an axial slit 44a′. In this case, the coupling ring 44′ can be easily expanded when being engaged with the protrusions 47 and 57 of the inner and outer roller shells 42 and 43. Thus, the roller assembly can be easily attached onto the shaft.

Further, the slit shape is not limited to that illustrated in FIG. 13. For example, the coupling ring 44′ may include a plurality of slits on the both axial ends thereof. Each slit herein has a short axial length and thereby does not reach the other axial end. In this case, the coupling ring 44′ is formed as an O-shaped ring.

(b) As another modification of the second exemplary embodiment, the convex-concave fitting and the sealing structure can be also employed as illustrated in FIG. 8.

### Third Exemplarly Embodiment

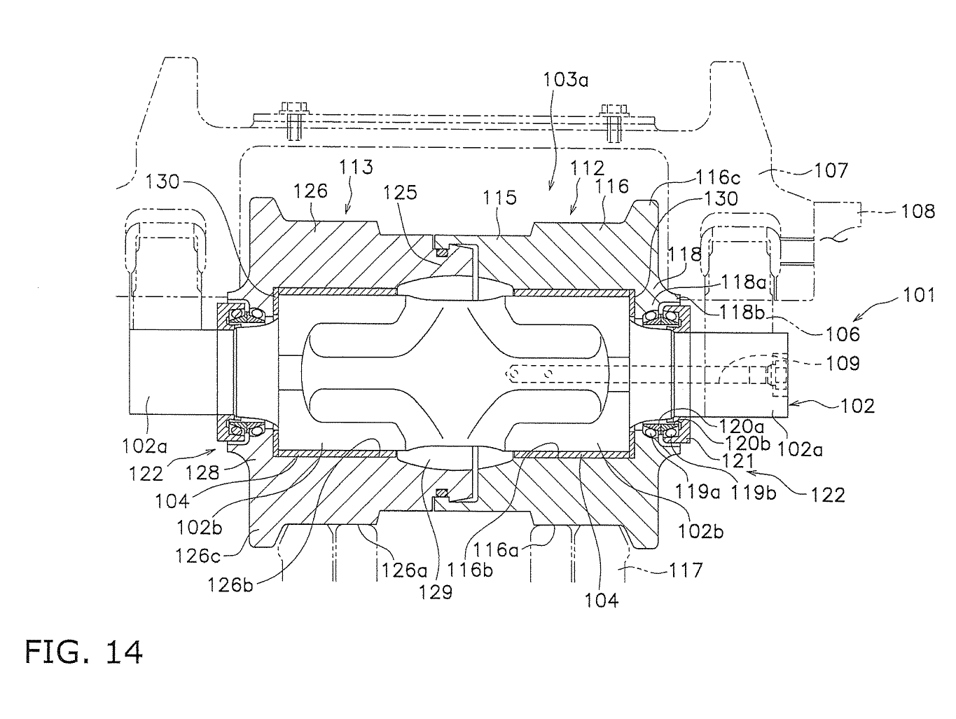

FIG. 14 illustrates a vertical cross-sectional view of each of roller wheels 101 for a track-type travelling vehicle according to a third exemplary embodiment of the present invention. The roller wheels 101 are disposed on the non-ground-engaging side of each of a pair of tracks. Each roller wheel 101 includes a shaft 102, a roller assembly 103a and two bushings 104 as bearings.

### Shaft

The shaft 102 includes a pair of small-diameter support portions 102a on the both ends thereof (i.e., the inner and outer ends thereof in the axial direction). Further, the shaft 102 includes a pair of bearing attached portions 102b in the axial center part thereof where the roller assembly 103a is disposed. The diameter of each bearing attached portion 102b is herein greater than that of each support portion 102a. The support portions 102a are respectively supported by a large bogie 107 through a pair of small bogies 106. Further, the large bogie 107 is fixed to a vehicle body frame 108. In other words, the shaft 102 is indirectly supported by the vehicle body frame 108. Further, the shaft 102 includes an oil supply port 109. The oil supply port 109 is outwardly formed from an inner end of the shaft 102 and is communicated to the outer peripheral surface of the shaft 102. It should be noted that the shaft 102 includes a recess in the axial center part thereof, i.e., a part interposed between the bearing attached portions 102b.

### Roller Assembly

The roller assembly 103a includes an inner roller shell 112 and an outer roller shell 113. The inner roller shell 112 is disposed on the inner position closer to the vehicle body frame 108, while the outer roller shell 113 is disposed outwards of the inner roller shell 112.

The inner roller shell 112 has a tubular shape and includes an inner interlocking portion 115 and an inner tread portion 116. As illustrated in FIG. 14, the inner interlocking portion 115 is disposed on the outer tip (i.e., the left-side tip), while the inner tread portion 116 is disposed inwards of the inner interlocking portion 115. The outer end of the inner interlocking portion 115 is coupled to the outer roller shell 113 by means of a straddle fitting structure.

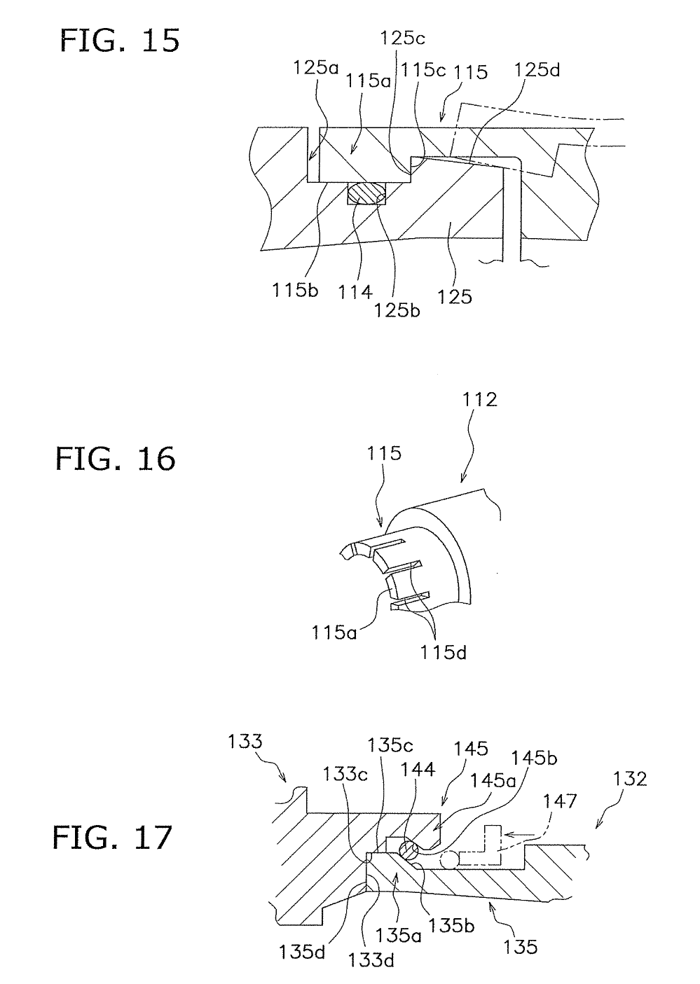

The inner interlocking portion 115, especially the outer end thereof, has a radial thickness less than that of the other part thereof. The inner interlocking portion 115 can be thereby elastically deformed easily. As illustrated in an enlarged view of FIG. 15, the inner interlocking portion 115 includes an annular interlocking protrusion 115a on the tip of the outer end thereof. The interlocking protrusion 115a is extended radial inwards. The interlocking protrusion 115a includes a sealing surface 115b and an interlocking surface 115c. The sealing surface 115b is the inner peripheral surface of the interlocking protrusion 115a, whereas the interlocking surface 115c is the inner surface of the interlocking protrusion 115a.

The diameter of the inner tread portion 116 is greater than that of the inner interlocking portion 115. The inner tread portion 116 includes a tread surface 116a on the outer peripheral surface thereof for making contact with track links 117. Further, the inner tread portion 116 includes a bearing attached surface 116b on the inner peripheral surface thereof. Yet further, the inner tread portion 116 includes an annular flange 116c on the innermost part thereof. The diameter of the annular flange 116 is greater than that of the other part of the inner tread portion 116.

Further, the inner roller shell 112 includes an inner boss 118 disposed further inwards of the inner tread portion 116. The inner boss 118 is formed in the radial inner part of the inner end of the inner roller shell 112. The inner boss 118 includes an inner peripheral protrusion 118a and an inner protrusion 118b. The inner peripheral protrusion 118a is annularly protruded radial inwards, whereas the inner protrusion 118b is annularly protruded axial inwards. A floating seal 122 is attached to the protrusions 118a and 118b. The floating seal 122 includes two O rings 119a and 119b, two sealing rings 120a and 120b and a snap ring 121.

Similarly to the inner roller shell 112, the outer roller shell 113 has a tubular shape, and includes an outer interlocking portion 125 on the inner tip thereof and an outer tread portion 126 on the outer side of the outer interlocking portion 125.

The diameter of the tip of the outer interlocking portion 125 is less than the outer diameter of the inner interlocking portion 115. Further, the outer interlocking portion 125 includes an annular interlocking groove 125a for receiving the interlocking protrusion 115a of the inner interlocking portion 115, as illustrated in the enlarged view of FIG. 15. The interlocking protrusion 115a of the inner interlocking portion 115 is interlocked with the interlocking groove 125a astride the tip protrusion of the outer interlocking portion 125. The inner and outer roller shells 112 and 113 are thereby interlocked with each other. The interlocking groove 125a includes an annular sealing groove 125b on the bottom surface thereof. A sealing member 114 is disposed in the annular sealing groove 125b. Further, the sealing surface 115b of the interlocking protrusion 115a is press-contacted to the sealing member 114. Yet further, the inner surface (right-side surface in FIG. 15) of the interlocking groove 125a functions as an interlocking surface 125c. The interlocking surface 115c of the interlocking protrusion 115a is interlocked with the interlocking surface 125c. Further, the outer interlocking portion 125 includes a tapered outer peripheral surface 125d on the tip thereof adjacent to the interlocking groove 125a. The diameter of the outer peripheral surface 125d is reduced from the outside to the inside.

The outer tread portion 126 is symmetric to the inner tread portion 116. Therefore, the outer tread portion 126 includes “a tread surface 126a”, “a bearing attached surface 126b”, “an annular flange 126c” and “an outer boss 128” respectively corresponding to “the tread surface 116a”, “the bearing attached surface 116b”, “the annular flange 116c” and “the inner boss 118” of the inner tread portion 116. Further, another floating seal 122, including two O rings, two sealing rings and the snap ring, is attached to the outer boss 128 of the outer roller shell 113, similarly to the flowing seal 122 attached to the outer boss 118.

With the aforementioned structure, the inner and outer roller shells 112 and 113 are coupled while the interlocking protrusion 115a of the inner interlocking portion 115 formed on the tip of the inner roller shell 112 is engaged with the interlocking groove 125a of the interlocking portion 125 formed on the tip of the outer roller shell 113. It should be noted that an oil reservoir 129 for lubricating oil is formed in a space produced between the shaft 102 and the inner periphery of the axial center part of the interlocked inner and outer interlocking portions 115 and 125.

### Bearings

The bushings 104 as bearings are respectively attached to the bearing attached surfaces 116b and 126b of the inner and outer roller shells 112 and 113. Therefore, the inner and outer roller shells 112 and 113 are rotatably supported by the shaft 102 through the bushings 104. Further, thrust washers 130 are respectively disposed between the axial ends of the bearing attached portions 102b and the edges of the inner and outer roller shells 112 and 113 in order to receive thrust force.

### Attachment

When the roller assembly 103a is attached onto the shaft 102, the thrust washers 130 are inserted into the inner peripheries of the inner and outer roller shells 112 and 113, and the bushings 104 are further inserted therein. Next, the inner and outer roller shells 112 and 113 are attached onto the shaft 102 from the both support portion 102a sides while the thrust washers 130 and the bushings 104 are attached thereto. Further, the interlocking protrusion 115a of the inner roller shell 112 is interlocked with the interlocking groove 125a astride the tip of the outer roller shell 113.

In the aforementioned attachment work, the interlocking protrusion 115a of the inner roller shell 112 is elastically deformed when pressed and moved across the outer peripheral surface 125d formed on the tip of the outer roller shell 113. The inner interlocking portion 115 with the interlocking protrusion 115a can be herein elastically deformed easily because the thickness thereof is less than that of the other part of the inner roller shell 112. Further, the outer roller shell 113 includes the tapered outer peripheral surface 125d on the tip thereof. Therefore, the interlocking protrusion 115a can be easily moved across the tapered outer peripheral surface 125d.

With the aforementioned structure, the inner and outer roller shells 112 and 113 are coupled to each other. Subsequently, the floating seals 122 are respectively attached to the bosses 118 and 128 of the inner and outer roller shells 112 and 113.

### Features

(1) The inner and outer roller shells 112 and 113 are coupled by interlocking the interlocking protrusion 115a formed in the inner interlocking portion 115 of the inner roller shell 112 with the interlocking groove 125a formed on the outer interlocking portion 125 of the outer roller shell 113. Therefore, deformation of the inner and outer roller shells 112 and 113 can be inhibited compared to the well-known coupling method using a press-fitted coupling ring. Therefore, it is possible to prevent uneven contact between the shaft 102 and the bushings 104 disposed in the inner peripheries of the inner and outer roller shells 112 and 113.

(2) The roller shell is split into only the inner and outer roller shells 112 and 113. Therefore, it is not required to prepare a member for supporting the floating seals 122. Further, it is not required to form screw holes in the roller shells for fixing such support members to the roller shells by means of screws. It is thereby possible to reduce the number of components of the roller assembly, easily manufacture the roller assembly and easily attach the roller assembly onto the shaft.

(3) It is possible to attach the roller assembly onto the shaft without using a large-sized press machine or the like. It is thereby possible to easily attach the roller assembly onto the shaft.

(4) The inner interlocking portion 115 of the inner roller shell 112 has a thin thickness. Therefore, the inner interlocking portion 115 with the interlocking protrusion 115a can be elastically deformed easily. Accordingly, it is possible to easily attach the roller assembly onto the shaft. Further, the outer roller 113 includes the tapered outer peripheral surface 125d on the tip thereof. Therefore, it is possible to more easily attach the roller assembly onto the shaft.

### Modification of Third Exemplary Embodiment

(a) The interlocking protrusion formed in the inner roller shell 112 may be formed in the outer roller shell 113 while the interlocking groove formed in the outer roller shell 113 may be formed in the inner roller shell 112.

(b) As illustrated in FIG. 16, the inner roller shell 112 may include a plurality of axial slits 115d in the inner interlocking portion 115 for further easily achieving elastic deformation of the inner interlocking portion 115.

(c) Arrangements of the annular sealing groove and the sealing member are not limited to those of the third exemplary embodiment. For example, the faced edges of the inner and outer roller shells 112 and 113 may be abutted to each other. Further, either or both of the edges may include an annular sealing groove and a sealing member may be disposed therein.

### Fourth Exemplarly Embodiment

### Structure

FIG. 17 illustrates a roller wheel according to a fourth exemplary embodiment of the present invention. The roller wheel of the fourth exemplary embodiment has basically the same structure as that of the third exemplary embodiment, excluding the engaging portions of inner and outer roller shells forming a roller assembly. Therefore, only the components different from those of the third exemplary embodiment will be hereinafter explained.

As illustrated in an enlarged view of FIG. 17, an inner roller shell 132 includes an inner engaging portion 135 on the outer tip thereof. The radial thickness of the engaging portion 135 is less than that of the other part of the inner roller shell 132. Further, the engaging portion 135 includes an inner engaging protrusion 135a on the tip thereof. The inner engaging protrusion 135a is annularly protruded radial outwards. The inner engaging protrusion 135a includes a tapered surface 135b on the inner surface of the outer periphery thereof. The diameter of the tapered surface 135a is inwardly reduced. Further, the radial outer surface of the outer periphery of the inner engaging protrusion 135a is formed as an inner fitting surface 135c, while the outer edge of the inner engaging protrusion 135a is formed as an axial positioning surface 135d.

An outer roller shell 133 includes an outer engaging portion 145 on the inner tip thereof. The radial thickness of the outer engaging portion 145 is less than that of the other part of the outer roller shell 133. Further, the outer engaging portion 145 includes an outer engaging protrusion 145a on the tip thereof. The outer engaging protrusion 145a has a tapered surface 145b on the inner surface of the inner periphery thereof. The diameter of the tapered surface 145b is increased outwards (to the left in FIG. 17). Further, the tapered surface 145b of the outer engaging protrusion 145a is faced to and vertically overlapped with the tapered surface 135b of the inner engaging protrusion 135b along the axial direction. It should be noted that an angle of 15 degrees or less is formed by the tapered surface 135b of the inner engaging protrusion 135a and the tapered surface 145b of the outer engaging protrusion 145.

Further, the outer roller shell 133 includes an outer fitting surface 133c and an axial positioning surface 133d in the inner periphery thereof. The outer fitting surface 133c and the axial positioning surface 133d are disposed further outwards (i.e., leftwards in FIG. 17) of the outer engaging portion 145. The outer fitting surface 133c is abutted to the inner fitting surface 135c of the inner engaging protrusion 135a. On the other hand, the axial positioning surface 133d is abutted to the axial positioning surface 135d.

The inner diameter of the inner tip of the outer engaging portion 145 of the outer roller shell 133 is greater than the outer diameter of the outer tip of the inner engaging portion 135 of the inner roller shell 132. The inner roller shell 132 is herein press-inserted into the outer roller shell 133 until the axial positioning surfaces 133d and 135d are abutted. Thus, the inner fitting surface 135c and the outer fitting surface 133c are fitted to each other.

In the present exemplary embodiment, a wedge ring 144 is disposed between the tapered surface 135b of the inner engaging protrusion 135a and the tapered surface 145b of the outer engaging protrusion 145. The wedge ring 144 has a circular cross-section and includes a notch on a part of the outer periphery thereof. Therefore, the diameter of the wedge ring 144 is expandable. The wedge ring 144 with a circular cross-section is press-inserted into the clearance between the tapered surfaces 135b and 145b from an inner position. The wedge ring 144 is then plastic-deformed within the clearance and the cross-section thereof becomes a wedge shape. Consequently, the wedge ring 144 inhibits movement between the inner and outer roller shells 132 and 133 as a wedge, and the inner and outer roller shells 132 and 133 are thereby more rigidly engaged.

With the aforementioned structure, the inner and outer engaging protrusions 135a and 145a are coupled through the wedge ring 144. The inner and outer roller shells 132 and 133 are thereby coupled to each other.

### Attachment

When a roller assembly 103b is attached onto a shaft 102, the thrust washers 130 are inserted into the inner peripheries of the inner and outer roller shells 132 and 133, and the bushes 104 are further inserted therein, similarly to the third exemplary embodiment. Further, the wedge ring 144 is preliminarily attached onto the outer periphery of the inner engaging portion 135 of the inner roller shell 132.

Next, the inner engaging portion 135 of the inner roller shell 132 is press-inserted into the inner periphery of the tip of the outer roller shell 133 while the thrust washers 30, the bush 104 and the wedge ring 144 are attached to the inner roller shell 132. The inner fitting surface 135c of the inner engaging protrusion 135a is herein joined to the outer fitting surface 133c of the outer roller shell 133, while the axial positioning surface 135d of the inner engaging protrusion 35a is abutted to the axial positioning surface 133d of the outer roller shell 133. Accordingly, the inner and outer roller shells 132 and 133 are appropriately positioned and fixed in the both radial and axial directions.

Next, the wedge ring 144, attached onto the inner roller shell 132, is press-inserted into the clearance between the tapered surface 135b of the inner engaging protrusion 135a and the tapered surface 145b of the outer engaging protrusion 145 using a tool 147 depicted with a dashed two-dotted line in FIG. 17. It should be noted that the tool 147 is a ring-shaped member and includes two circumferentially split parts. The wedge ring 144 is thus fixed between the tapered surfaces 135b and 145b, and the inner and outer roller shells 132 and 133 are more rigidly coupled to each other.

The fourth exemplary embodiment can achieve the same advantageous effects as those of the aforementioned exemplary embodiment. Further, it is possible to easily attach the roller assembly onto the shaft.

### Modification of Fourth Exemplary Embodiment

(a) The specific structure of the coupling portions of the inner and outer roller shells is not limited to the aforementioned fourth exemplary embodiment. For example, the coupling portion of the inner roller shell may have the structure of the coupling portion of the outer roller shell in the fourth exemplary embodiment, whereas the coupling portion of the outer roller shell may have the structure of the coupling portion of the inner roller shell in the fourth exemplary embodiment.

(b) No sealing member is used in the example of FIG. 17. However, similarly to the third exemplary embodiment, a sealing groove may be formed on either or both of the contacted surfaces of the inner and outer roller shells and a sealing member may be disposed therein in order to inhibit leakage of lubricating oil to the outside.

### Fifth Exemplarly Embodiment

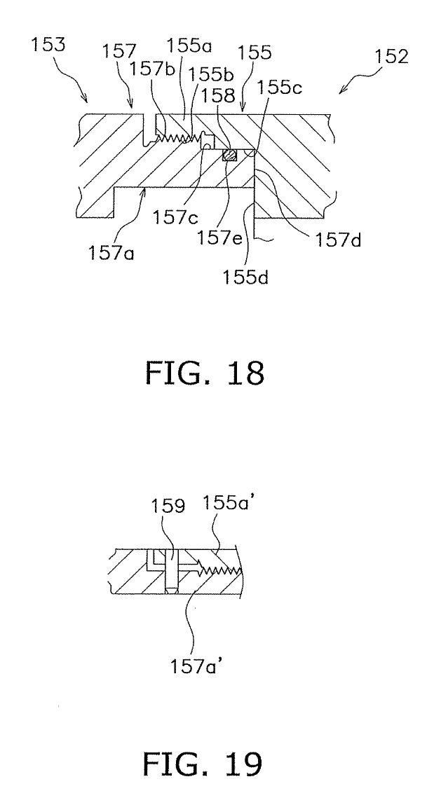

FIG. 18 illustrates a roller wheel according to a fifth exemplary embodiment of the present invention. The roller wheel of the fifth exemplary embodiment has basically the same structure as that of the third exemplary embodiment, excluding the coupling portions of the inner and outer roller shells forming a roller assembly. Therefore, only the components different from those of the third exemplary embodiment will be hereinafter explained.

As illustrated in an enlarged view of FIG. 18, an inner roller shell 152 includes an inner engaging portion 155 on the outer tip thereof. The radial thickness of the inner engaging portion 155 is less than that of the other part of the inner roller shell 152. The inner engaging portion 155 includes a female threaded portion 155b on the inner peripheral surface of a tip 155a. Further, the inner engaging portion 155 includes an inner fitting surface 155c on the inner peripheral surface thereof. The inner fitting surface 155c is disposed inwards of the female threaded portion 155b. Further, the inner engaging portion 155 includes an axial positioning surface 155d on the outer edge (i.e., the left-side edge in FIG. 18) thereof.

An outer roller shell 153 includes an outer engaging portion 157 on an inner tip 157a. The radial thickness of the outer engaging portion 157 is less than that of the other part of the outer roller shell 153. Further, the outer engaging portion 157 includes a male threaded portion 157b on the outer periphery thereof. The male threaded portion 157b is screwed into the female threaded portion 155b of the inner engaging portion 155. Further, the outer engaging portion 157 includes an outer fitting surface 157c and an axial positioning surface 157d. The outer fitting surface 157c is disposed on the tip side (inwards, i.e., rightwards in FIG. 18) of the male threaded portion 157b. The axial positioning surface 157d is the tip end of the outer engaging portion 157. The outer fitting surface 157c is abutted to the inner surface 155c of the inner roller shell 152, while the axial positioning surface 157d is abutted to the axial positioning surface 155d of the inner roller shell 152. With the structure, the inner and outer roller shells 152 and 153 are appropriately positioned in the both radial and axial directions.

It should be noted that the outer roller shell 157 includes a sealing groove 157e on the outer fitting surface 157c and a sealing member 158 is disposed in the sealing groove 157e.

The fifth exemplary embodiment described above also can achieve the same advantageous effects as those achieved by the aforementioned respective exemplary embodiments.

It should be noted that each of engaging portions 155a′ and 157a′ may include a through hole penetrating in the radial direction, and a pin 159 may be disposed in the through holes for preventing rotation of the inner and outer roller shells, as illustrated in FIG. 19.

According to the illustrated embodiments, it is possible to inhibit inward deformation of the respective roller shells of a roller wheel for a track-type travelling vehicle and thereby inhibit uneven contact between the shaft and the bearings disposed in the inner peripheries of the roller shells.

1. A roller wheel for a track-type travelling vehicle, the roller wheel disposed on a non-ground-engaging side of a track, the roller wheel supported by a vehicle body frame, the roller wheel comprising:
a shaft supported by the vehicle body frame;
a roller assembly disposed on an outer periphery of the shaft; and
a bearing allowing the roller assembly to be rotatably supported by the shaft therethrough,
wherein the roller assembly includes
a tubular inner roller shell disposed closer to the vehicle body frame, and
a tubular outer roller shell disposed outwards of the inner roller, the tubular outer roller shell being coupled to the inner roller shell by a straddle fitting structure,
the straddle fitting structure includes
an inner engaging portion formed on an outer periphery of an outer end of the inner roller shell,
an outer engaging portion formed on an outer periphery of an inner end of the outer roller shell, and
a coupling ring engaged astride with the inner and outer engaging portions for coupling the inner and outer roller shells,
each of the inner and outer engaging portions of the inner and outer roller shells includes an annular groove partially having an axially extended protrusion in a circumferential direction thereof, and
the coupling ring includes a plurality of split rings, each of the split rings including a pair of legs fitted into the annular grooves of the inner and outer roller shells, each of the legs partially having an engaging portion engaged with a corresponding one of the protrusions of the annular grooves.

2. (canceled)

3. (canceled)

4. The roller wheel for a track-type travelling vehicle recited in claim 1, wherein
the split rings are two half-split rings respectively formed in a semicircular shape.

5. The roller wheel for a track-type travelling vehicle recited in claim 4, wherein
each of the half-split rings includes
an engaging part formed in one of circumferential ends thereof, the engaging part being engaged with the engaging part of the other of the half-split rings, and
a groove axially formed in the other of the circumferential ends thereof, and
the coupling ring further includes a fixation member press-fitted into the groove of the half-split rings for fixing the half-split rings.

6. The roller wheel for a track-type travelling vehicle recited in claim 4, wherein
each of the half-split rings includes a radially penetrating through hole in each of both circumferential ends thereof, and
the coupling ring further includes two pins for fixing the half-split rings, each pin penetrating through the through holes formed in corresponding circumferential ends of the half-split rings.

7. A roller wheel for a track-type travelling vehicle, the roller wheel disposed on a non-ground-engaging side of a track, the roller wheel supported by a vehicle body frame, the roller wheel comprising:
a shaft supported by the vehicle body frame;
a roller assembly disposed on an outer periphery of the shaft; and
a bearing allowing the roller assembly to be rotatably supported by the shaft therethrough,
wherein the roller assembly includes
a tubular inner roller shell disposed closer to the vehicle body frame, and
a tubular outer roller shell disposed outwards of the inner roller, the tubular outer roller shell being coupled to the inner roller shell by a straddle fitting structure,
the straddle fitting structure includes
an inner engaging portion formed on an outer periphery of an outer end of the inner roller shell,
an outer engaging portion formed on an outer periphery of an inner end of the outer roller shell, and
a coupling ring engaged astride with the inner and outer engaging portions for coupling the inner and outer roller shells,
each of the inner and outer engaging portions of the inner and outer roller shells includes a protrusion extended radial outwards, and
the coupling ring is an annular member including a pair of legs on an inner periphery thereof for allowing the pair of legs to be engaged with the protrusions of the inner and outer roller shells.

8. The roller wheel for a track-type travelling vehicle recited in claim 7, wherein
each of the protrusions of the inner and outer roller shells is tapered, with an outer diameter thereof increased in proportion to distance from the other of the inner and outer roller shells.

9. The roller wheel for a track-type travelling vehicle recited in claim 8, wherein
each of the inner and outer roller shells includes the protrusion continuously on the entire circumference thereof.

10. The roller wheel for a track-type travelling vehicle recited in claim 7, wherein
the coupling ring includes at least an axial slit for easy elastic deformation thereof.

11. The roller wheel for a track-type travelling vehicle recited in claim 7, wherein
each of the outer and inner ends with the protrusions in the inner and outer roller shells is elastically deformable radially inwards.

12. A roller wheel for a track-type travelling vehicle, the roller wheel disposed on a non-ground-engaging side of a track, the roller wheel supported by a vehicle body frame, the roller wheel comprising:
a shaft supported by the vehicle body frame;
a roller assembly disposed on an outer periphery of the shaft; and
a bearing allowing the roller assembly to be rotatably supported by the shaft therethrough,
wherein the roller assembly includes
a tubular inner roller shell disposed closer to the vehicle body frame, and
a tubular outer roller shell disposed outwards of the inner roller, the tubular outer roller shell being coupled to the inner roller shell by a straddle fitting structure,
wherein the straddle fitting structure includes
an inner interlocking portion formed on an outer end of the inner roller shell, and
an outer interlocking portion formed on an inner end of the outer roller shell, and
the straddle fitting structure couples the inner and outer roller shells, with one of the inner and outer interlocking portions of the inner and outer roller shells being interlocked astride with the other of the inner and outer interlocking portions of the inner and outer roller shells.

13. The roller wheel for a track-type travelling vehicle recited in claim 12, wherein
at least one of the inner and outer interlocking portions of the inner and outer roller shells includes an interlocking protrusion extended radial inwards, and
at least the other of the inner and outer interlocking portions of the inner and outer roller shells includes an interlocked groove for allowing the interlocking protrusion to be engaged therein.

14. The roller wheel for a track-type travelling vehicle recited in claim 13, wherein
at least one of the inner and outer interlocking portions of the inner and outer roller shells has a radial thickness less than a radial thickness of the other part of the corresponding one or both of the inner and outer roller shells.

15. The roller wheel for a track-type travelling vehicle recited in claim 14, wherein
at least one of the inner and outer roller shells includes a tapered outer peripheral surface on the end thereof including the interlocking groove, the tapered outer peripheral surface having a diameter reduced towards a tip thereof from the interlocking groove.

16. The roller wheel for a track-type travelling vehicle recited in claim 15, wherein
at least one of the inner and outer interlocking portions includes a plurality of axially extended slits.

17. The roller wheel for a track-type travelling vehicle recited in claim 13, wherein
the interlocking groove includes an annular sealing-member attaching groove on a bottom surface thereof,
mthe straddle fitting structure further includes a sealing member disposed in the annular groove formed therein, and
the interlocking protrusion is press-contacted to the sealing member with an inner peripheral surface thereof.

18. The roller wheel for a track-type travelling vehicle recited in claim 12, wherein
the inner and outer interlocking portions of the inner and outer roller shells include slanted surfaces radially faced to each other,
the straddle fitting structure further includes a wedge ring to be inserted between the slanted surfaces thereof, the wedge ring being partially notched for expanding a diameter thereof, and
the inner and outer interlocking portions of the inner and outer roller shells are interlocked through the wedge ring.

19. A roller wheel for a track-type travelling vehicle, the roller wheel disposed on a non-ground-engaging side of a track, the roller wheel supported by a vehicle body frame, the roller wheel comprising:
a shaft supported by the vehicle body frame;
a roller assembly disposed on an outer periphery of the shaft; and
a bearing allowing the roller assembly to be rotatably supported by the shaft therethrough,
wherein the roller assembly includes
a tubular inner roller shell disposed closer to the vehicle body frame, and
a tubular outer roller shell disposed outwards of the inner roller, the tubular outer roller shell being coupled to the inner roller shell by a straddle fitting structure,
wherein one of the inner and outer interlocking portions of the inner and outer roller shells includes a male threaded portion on an outer peripheral surface thereof, and
the other of the inner and outer interlocking portions of the inner and outer roller shells includes a female threaded portion allowing the male threaded portion to be screwed therein.
